(19) United States
(12) Patent Application Publication
(10) Pub. No.: US 2013/0340566 A1
(43) Pub. Date: Dec. 26, 2013

(54) HOUSING FOR A GEAR MECHANISM

(71) Applicant: Robert Bosch GmbH, Stuttgart (DE)

(72) Inventors: Ralf Kleine-Brockhoff, Dorsten (DE); Dominikus Daners, Herten (DE); Marco Lehmann, Wuppertal (DE); Claudia Schweihoff, Bochum (DE)

(21) Appl. No.: 13/922,048

(22) Filed: Jun. 19, 2013

(30) Foreign Application Priority Data
Jun. 20, 2012 (DE) 10 2012 012 140.7

(51) Int. Cl. F16H 57/021

(52) U.S. Cl. CPC F16H 57/021
USPC 74/606 R

(57) ABSTRACT

A housing for a gear mechanism, in particular a planetary gear mechanism, includes at least one gear-mechanism housing part that has at least one structure configured to reinforce the housing. The housing further includes at least one shaft mounted in the housing and gear-mechanism gearwheels. The housing is optimized with regard to its weight and its strength by virtue of the structure configured to reinforce the housing. The structure is configured as one or more of an undulating structure oriented in the circumferential direction of the gear-mechanism housing part and a bead structure oriented in the radial direction of the gear-mechanism housing part.

This application claims priority under 35 U.S.C. §119 to patent application no. DE 10 2012 012 140.7, filed on Jun. 20, 2012 in Germany, the disclosure of which is incorporated herein by reference in its entirety.

### BACKGROUND

The disclosure relates to a housing for a gear mechanism, in particular a planetary gear mechanism, having at least one gear-mechanism housing part which has a structure which reinforces the housing, having, furthermore, a shaft and gear-mechanism gearwheels, the shaft being mounted in the housing.

A housing of this type for a gear mechanism is known from DE 101 34 245 A1. The gear mechanism has an inner power division means, consisting of a large gearwheel which is connected to an input shaft and an output shaft, is provided with an external toothing system and is surrounded by eight pinion shafts, the toothed pinions of which mesh with the large gearwheel. These entire components are arranged and mounted in at least two gear-mechanism housing parts, of which at least one part is a housing cover. Here, the housing cover is configured additionally as a torque support, the entire housing being supported via said torque support on a component which surrounds the gear mechanism. For the capability of being assembled more simply, the housing cover is divided into a plurality of components which are screwed to one another. The housing cover has ribs on the corresponding joining points and also in further regions, which ribs serve to reinforce the housing cover.

### SUMMARY

The disclosure is based on the object of providing a housing for a gear mechanism, which housing is optimized with regard to its weight and its strength.

This object is achieved by virtue of the fact that the structure which reinforces the housing is an undulating structure which is oriented in the circumferential direction of a gear-mechanism housing part and/or a bead structure which is oriented in the radial direction of a gear-mechanism housing part. Each of the two structures, namely the undulating structure and the bead structure, makes it possible per se or else in combination with the respective other structure to configure the gear-mechanism housing part in a manner which is optimized in terms of strength and also weight. The undulating structure optimizes the corresponding rather flat and torsion-susceptible housing wall of the gear-mechanism housing part to produce a torsionally rigid component without a weight-intensive addition of material taking place which occurs, for example, if webs or ribs are attached. Here, the undulating structure can have flowing transitions, curved transitions or else angled-away transitions. Here, the term undulating structure includes, for example, a rectangular structure, a trapezoidal structure and a zigzag structure which can in each case have chamfered or rounded straight lines. As an alternative or preferably in addition to the undulating structure, the bead structure is also suitable without appreciable addition of material to increase the rigidity and strength of the gear-mechanism housing part. The bead structure divides the housing wall of the gear-mechanism housing part into two part sections which are unwound with respect to one another. Together with the undulating structure, the bead structure affords the advantage that the number of individual elements, into which the housing wall is divided, is doubled without further measures. The undulating structure and the bead structure can also be configured such that they interact as a honeycomb structure. In this particularly advantageous combination of the undulating structure and the bead structure, a considerable increase in the strength of the gear-mechanism housing part is achieved with a configuration of the gear-mechanism housing part which is, almost weight-neutral.

In one development of the disclosure, the undulating structure is of asymmetrical configuration. Here, in turn, in a further refinement of the disclosure, the undulating structure can have a distribution and thickness which change in the circumferential direction and are adapted to the force flow in the gear-mechanism housing part and to the loading of the gear-mechanism housing part. For the corresponding design of the undulating structure, it can be determined where there are highly loaded and less loaded regions of the gear-mechanism housing part which are then configured with an asymmetrical undulating structure, an adapted distribution and an adapted thickness. Here, in particular, the thickness can be reduced considerably in less loaded locations, the weight of the gear-mechanism housing part being reduced considerably by these measures in comparison with a corresponding gear-mechanism housing part which is reinforced by ribs. Weight reduction can also be achieved in comparison with a gear-mechanism housing part with a flat and therefore torsion-intensive housing wall.

In a further refinement of the disclosure, the bead structure penetrates the undulating structure at least in sections. For example, it is the case here that only a bead structure or undulating structure is present in a less loaded region of the wall of the gear-mechanism housing part and both a bead structure and an undulating structure which penetrate one another are present in more highly loaded, and highly loaded, regions.

In one development of the disclosure, the bead structure is likewise of asymmetrical configuration. This means that the bead structure is not of circular configuration. In a further refinement of the disclosure, the bead structure is formed as a multiple bead structure at least on a part circumference of the gear-mechanism housing part. A multiple bead structure of this type is arranged, in particular, in highly loaded regions of the gear-mechanism housing part. Here, the single bead structure can be merged seamlessly into a multiple bead structure.

In one advantageous development of the disclosure, the undulating structure is configured differently on both sides of the bead structure which divides the undulating structure. Once again, this refinement can take special rigidity requirements into consideration.

In one development of the disclosure, a viewing-hole opening in the gear-mechanism housing part is bordered by a part section of the bead structure and/or the undulating structure and/or a rib. This refinement also makes a reinforced viewing-hole structure possible with a minimum material outlay for additional reinforcements. In accordance with the respective requirements, one or more viewing-hole openings can be provided on the housing part, and/or they can be arranged, in particular, at a lowly loaded location of the gear-mechanism gear-mechanism housing part.

In one development of the disclosure, the gear-mechanism housing part is a housing cover. The subject matter of the disclosure can be implemented particularly advantageously, in particular, on a gear-mechanism housing part of flat configuration of this type. However, the subject matter of the disclosure can also be applied to all other gear-mechanism housing parts.

In a further refinement of the disclosure, the gear-mechanism gear-mechanism housing part has at least one torque support. Here, the gear-mechanism gear-mechanism housing part is then preferably the housing cover. Here, the attachment of the torque support to the housing cover can be optimized particularly advantageously, by the undulating structure being configured with finer elements and with thicker wall thicknesses, for example, in the region of the attachment than in other regions and, possibly additionally, the bead structure being configured as a multiple bead structure in the region of the attachment of the torque support.

In one development of the disclosure, the housing is part of a continuous-flow power plant gear mechanism, in particular a tidal power plant gear mechanism or a wind power plant gear mechanism. In continuous-flow power plant gear mechanisms of this type, high power outputs are to be transmitted and at the same time high service lives of the corresponding gear mechanisms have to be ensured. These requirements are met by the strength-optimized design of the gear-mechanism housing parts, whereas the weight reduction of the gear mechanism which is configured in this way can be produced at the same time.

### BRIEF DESCRIPTION OF THE DRAWINGS

Further advantageous refinements of the disclosure are to be gathered from the description of the drawings, in which exemplary embodiments of the disclosure which are shown in the figures are described in greater detail.

In the drawings:

FIG. 1 shows a diagrammatic side view of a wind power plant with a gear-mechanism housing part which is configured according to the disclosure,

FIG. 2 shows a plan view of a gear-mechanism housing part which is configured according to the disclosure in the form of a housing cover with integrally formed torque supports,

FIG. 3 shows a section A-A through the housing cover according to FIG. 1,

FIG. 4 shows a perspective view of a housing cover with integrally formed torque supports and with a multiple bead structure,

FIG. 5 shows a perspective view of a housing cover similar to FIG. 3,

FIG. 6 shows a housing cover which is configured only as a bearing cap,

FIG. 7 shows a housing cover which is provided with two projecting lugs, and

FIG. 8 shows a housing cover which is provided with an annular flange.

### DETAILED DESCRIPTION

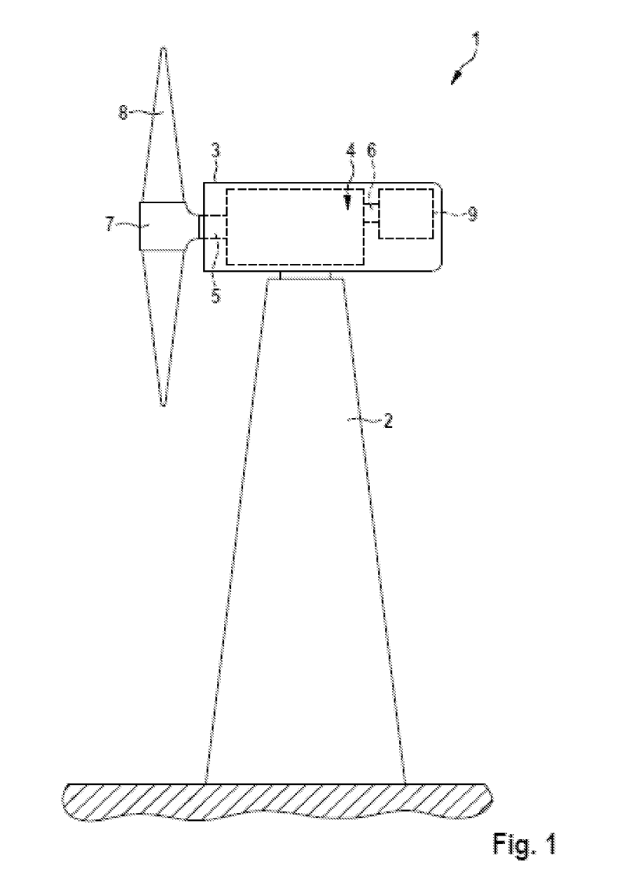

FIG. 1 shows a side view of a wind power plant 1 with its essential assemblies. The wind power plant 1 has a tower 2, on which a nacelle 3 which is mounted such that it can be rotated about a vertical axis is arranged in the form of a machine housing. The planetary gear mechanism 4 which has a plurality of gear-mechanism housing parts is fastened in a rotationally fixed manner in the nacelle 3, the planetary gear mechanism 4 having shafts in the form of a drive shaft 5 and an output shaft 6. The drive shaft 5 of the planetary gear mechanism 4 is connected to a hub 7 of a rotor which has a plurality of rotor blades 8. The output shaft 6 is connected rotationally to a drive apparatus which is to be driven in the form of a generator 9. The planetary gear mechanism 4 is designed in such a way that it converts a slow rotational movement of the drive shaft 5 into a rapid rotational movement of the output shaft 6 which is configured as a high-speed output shaft. To this end, the planetary gear mechanism 4 has one or more planetary stages which interact with the output shaft 6 via a terminating spur gear mechanism. Electrical energy is generated by means of the wind power plant 1, by the rotor which is set in a rotational movement by the wind introducing the rotational movement of the drive shaft 5 into the planetary gear mechanism 4. The planetary gear mechanism 4 converts the rotational movement into a more rapid rotational movement and, finally, the rapid rotational movement is transmitted via the output shaft 6 to the generator 9 in order to generate current.

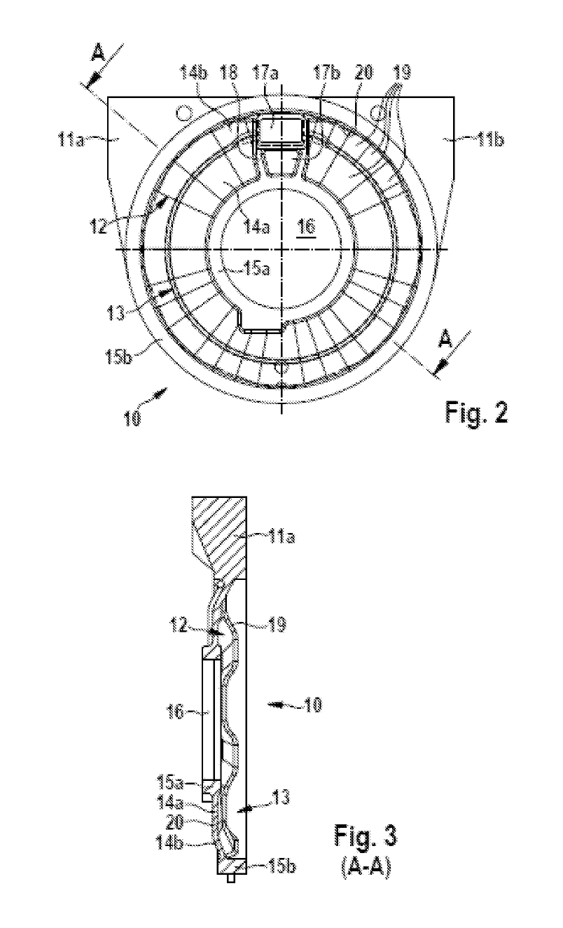

FIG. 2 shows a gear-mechanism housing part of the planetary gear mechanism 4, which gear-mechanism housing part is configured as a housing cover 10 with two integrally formed torque supports 11a, 11b. The planetary gear mechanism 4 is fixed in a rotationally fixed manner in the nacelle 3 by means of the torque supports 11a, 11b. The housing cover 10 has a structure which reinforces the housing and is configured as an undulating structure 12 which is oriented in the circumferential direction of the housing cover 10 and a bead structure 13 which is oriented in the radial direction or circumferential direction of the housing cover 10. In this exemplary embodiment, the bead structure 13 is of approximately circular configuration and divides the undulating structure into an inner region 14a and an outer region 14b. The inner region 14a of the undulating structure 12 adjoins an inner flange 15a of the housing cover 10, which inner flange 15a encloses a housing opening 16, through which the drive shaft 5 or the output shaft 6 is guided out of the planetary gear mechanism 4.

The outer region 14b of the undulating structure 12 is delimited by an outer flange 15b which represents the outer boundary of the housing cover 10 and merges into the torque supports 11a, 11b.

Two viewing holes 17a, 17b which lie above one another and extend along an undulating structure 12 between the inner flange 15a and the outer flange 15b are let into the housing cover 10. The viewing holes 17a, 17b are bordered in the regions between the inner flange 15a and the outer flange 15b by ribs 18 which are formed at least partially by the undulating structure 12 and the bead structure 13. However, the above-described viewing hole 17b can also be configured as a ribbed undulating structure 12. It is the case here that individual undulating structures 12 can be reinforced quite generally with ribs.

In the region of the torque support 11b, the outer region 14b of the undulating structure is configured in such a way that, in the outer region 14b of the undulating structure 12, two or more undulations 19 interact with an undulation 19 of the inner region 14a of the undulating structure 12 separated by the bead 20 of the bead structure 13.

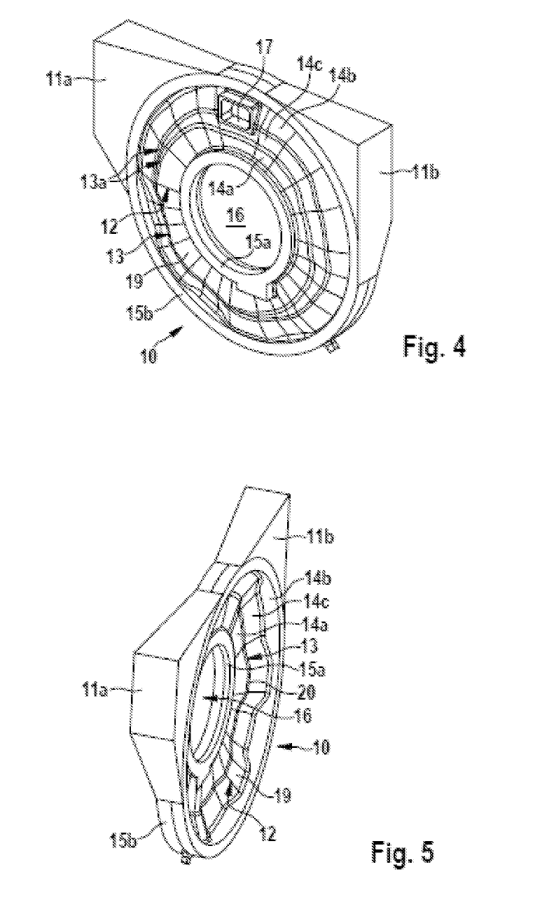

FIG. 3 shows a section A-A according to FIG. 1 through the housing cover 10. The different course of the undulating structure 12 with the undulations 19 is clearly apparent from this sectional illustration, likewise as from the perspective illustrations of FIGS. 4 and 5, the undulating structure 12 being divided by the bead 20 of the bead structure 13 into the inner region 14a and the outer region 14b. Furthermore, the configuration of the torque support 11a, the outer flange 15b and the inner flange 15a which encloses the housing opening 16 can be seen clearly. Finally, the different wall thickness of the housing cover 10, for example between the inner region 14a and the outer region 14b, can be seen in said section both in the radial direction and in the circumferential direction.

FIG. 4 shows a perspective view of a housing cover 10 which is configured in a similar way to the housing cover 10 which is shown in FIG. 1. A difference, as shown on the left-hand side, is that the (single) bead structure 13 merges into a multiple bead structure 13a which is configured, on the right-hand side of FIG. 3, to be continuous as far as into the lower region of the housing cover 10. Correspondingly, the multiple bead structure 13a divides the undulating structure 12 into a total of three regions 14a, 14b, 14c which can all have different undulating forms. Furthermore, said housing cover 10 has only one viewing hole 17.

FIG. 5 shows another perspective view of a housing cover 10, from which the asymmetrical course of the undulating structure 12 and the multiple bead structure 13a is likewise clearly apparent.

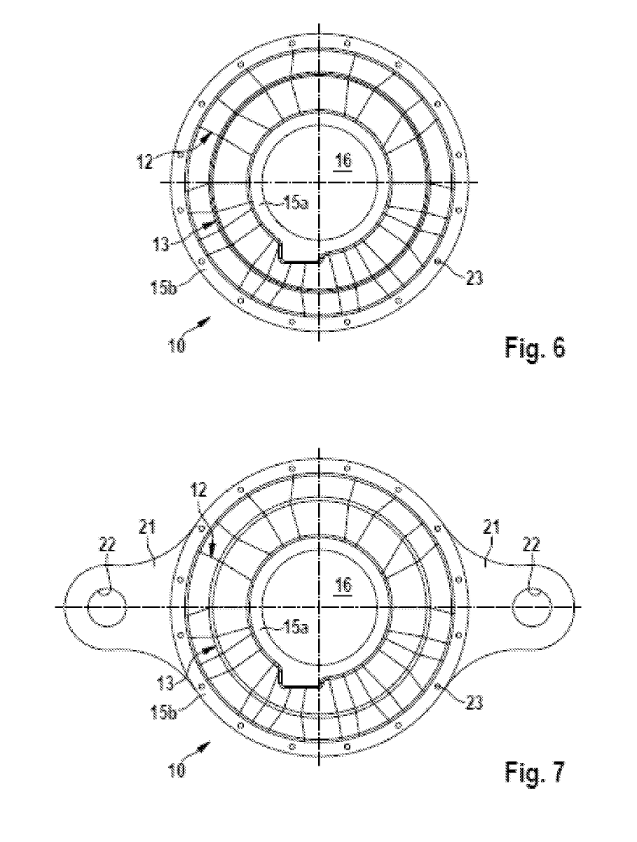

FIG. 6 shows a housing cover 10 which is configured as a pure bearing cap and accordingly does not have any integrally formed torque supports 11a, 11b and therefore has a continuous outer flange 15b. Holes 23 for inserting fastening screws are machined into the outer flange 15b. Otherwise, said housing cover 10 is configured as described above.

The housing cover 10 according to FIG. 7 has two lateral lugs 21 which are provided in each case with an opening 22 for fastening torque supports. Otherwise, said housing cover 10 is also configured as described above.

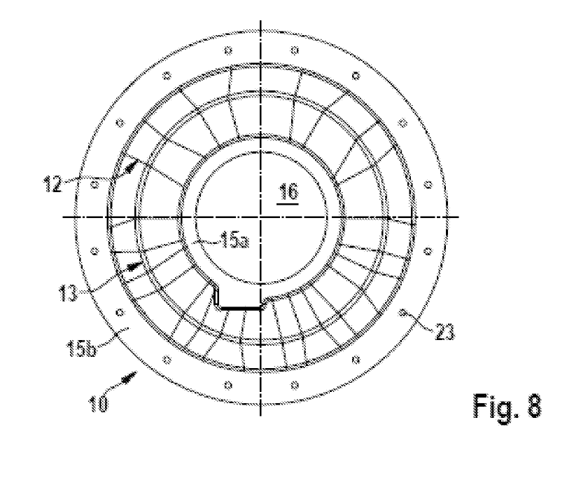

In the housing cover 10 which is shown in FIG. 8, the outer flange 15b is configured as an annular flange with a number of holes 23. The housing cover 10 and the entire planetary gear mechanism 4 are fixed in a rotationally fixed manner in the nacelle 3 by means of screws which are screwed into said holes 23 which are configured, for example, as threaded holes.

Finally, it is noted that any desired combinations, in particular, of the individual features which are described in the figures can be implemented within the scope of the disclosure.

### LIST OF DESIGNATIONS

1 Wind power plant

### 2 Tower

### 3 Nacelle

4 Planetary gear mechanism
5 Drive shaft
6 Output shaft

### 7 Hub

8 Rotor blade

### 9 Generator

10 Housing cover
11a, 11b Torque support
12 Undulating structure
13 Bead structure
13a Multiple bead structure
14a Inner region
14b Outer region
14c Central region
15a Inner flange
15b Outer flange
16 Housing opening
17, 17a, 17b Viewing hole

### 18 Rib

### 19 Undulation

### 20 Bead

### 21 Lug

### 22 Opening

23 Hole

What is claimed is:

1. A housing for a gear mechanism, comprising:
at least one gear-mechanism housing part having a structure configured to reinforce the housing;
at least one shaft mounted in the housing; and
gear-mechanism gearwheels,
wherein the structure configured to reinforce the housing is one or more of an undulating structure oriented in the circumferential direction of the gear-mechanism housing part and a bead structure oriented in the radial direction of the gear-mechanism housing part.

2. The housing according to claim 1, wherein the undulating structure is of asymmetrical configuration.

3. The housing according to claim 1, wherein the undulating structure has a changing distribution and thickness in the circumferential direction of the gear-mechanism housing part.

4. The housing according to claim 1, wherein the bead structure penetrates the undulating structure.

5. The housing according to claim 1, wherein the bead structure is of asymmetrical configuration.

6. The housing according to claim 1, wherein the bead structure is formed as a multiple bead structure at least on a part circumference of the gear-mechanism housing part.

7. The housing according to claim 1, wherein the undulating structure is configured differently on both sides of the bead structure.

8. The housing according to claim 1, wherein a viewing-hole opening formed in the gear-mechanism housing part is bordered by one or more of a part section of the bead structure, the undulating structure, and a rib.

9. The housing according to claim 1, wherein the gear-mechanism housing part is a housing cover.

10. The housing according to claim 1, wherein the gear-mechanism housing part has at least one torque support.

11. The housing according to claim 1, wherein the housing is part of a continuous-flow power plant gear mechanism.

12. A wind power plant, comprising:
a housing for a gear mechanism, the housing including:
at least one gear-mechanism housing part having a structure configured to reinforce the housing;
at least one shaft mounted in the housing; and
gear-mechanism gearwheels,
wherein the structure configured to reinforce the housing is one or more of an undulating structure oriented in the circumferential direction of the gear-mechanism housing part and a bead structure oriented in the radial direction of the gear-mechanism housing part.

13. The housing according to claim 1, wherein the gear mechanism is a planetary gear mechanism.

14. The housing according to claim 11, wherein the housing is part of a tidal power plant gear mechanism or a wind power plant gear mechanism.
